(19) United States
(12) Patent Application Publication
(10) Pub. No.: US 2011/0259489 A1
(43) Pub. Date: Oct. 27, 2011

(54) PLIES OF THREADS COMPRISING ELECTRICALLY CONDUCTING REGIONS

(75) Inventors: Hervé Queraud, Clermont-Ferrand (FR); Henri Hinc, Romagnat (FR)

(73) Assignees: Michelin Recherche et Technique S.A., Granges-Paccot (CH); SOCIETE DE TECHNOLOGIE MICHELIN, Clermont-Ferrand (FR)

(21) Appl. No.: 12/988,500

(22) PCT Filed: Apr. 1, 2009
(86) PCT No.: PCT/EP2009/002363

§ 371 Date: Apr. 4, 2011

(30) Foreign Application Priority Data
Apr. 16, 2008 (FR) 0852556

(51) Int. Cl. B60C 19/08; B60C 1/00; D04H 13/00; B32B 5/12

(52) U.S. Cl. 152/152.1; 428/114; 28/140

(57) ABSTRACT

Reinforcing ply (13, 14, 15) designed to produce a tire (1) formed of an assembly of threads, mostly coated with a poorly electrically conducting rubber compound (130, 140, 150), parallel with each other and making a given angle with the longitudinal direction of said ply. The ply includes through-threads (131, 141, 151) coated with one or more layers of rubber compounds, of which the outer layer is formed of an electrically conducting rubber compound. The through-threads are inserted between the threads coated with the poorly electrically conducting rubber compound (130, 140, 150) at a pitch and in a given arrangement in such a way as to form one or more electrically conducting pathways between the upper part and the lower part of the ply.

The field of the invention relates to tires intended to be fitted to transport vehicles. More specifically, the invention relates to the problem of the flow of electrical charges in tires made with electrically nonconducting rubber compounds.

In order to improve rolling resistance and reduce fuel consumption, modern tires contain rubber compounds that comprise, by way of predominant filler, electrically nonconducting fillers, such as silica, or compounds with a very small percentage of carbon black, and that are used for example to make treads. A tire of this kind is described, by way of illustration, in publication EP 0 501 227.

Owing to the very high resistivity of these compounds, their use has been accompanied by the development of numerous technical solutions for preventing the buildup of static electricity and allowing charges to flow to the ground when the vehicle is moving. The drawbacks associated with the buildup of electrical charges are well known to manufacturers, and vary widely, from interference with the operation of the vehicle radio, to electric shocks received by occupants when alighting from the vehicle, and accelerated ageing of the tire due to ozone formation.

Publication U.S. Pat. No. 5,518,055 describes a tire in which the tread, made from a nonconducting compound, is coated with a thin layer of conducting compound. This layer is in contact with the sidewall compounds, which are themselves also electrically conducting in order to allow the electrical charges to flow.

Another solution, set out in publication EP 0 658 452, is to place an insert in the tread. This insert, which extends radially preferably all the way around the tire circumference, is made with an electrically conducting rubber compound, and connects the outer surface of the tread either to one of the crown reinforcing plies or to the carcass reinforcement, or to any other part connected to the tire tread and sufficiently electrically conducting, each of these plies being electrically conducting. Many improvements have been made to this principle, depending on whether the tread comprises one or more layers of conducting or nonconducting materials, and are set out for example in publications EP 0 925 903 and EP 0 963 302.

All these methods are aimed at connecting the outer surface of the tread to an immediately adjacent part of the inner region of the tire crown, such as the sidewall, a crown reinforcing ply, or a carcass reinforcing ply, which have properties of electrical conduction.

However, recent developments in tires, still aimed at improving rolling resistance, have increased the use of poorly electrically conducting compounds based on silica, in most of the tire components that are likely to perform mechanical work while said tire is rolling. Thus, in addition to the treads, such compounds are used in the manufacture of the sidewalls, the carcass reinforcing plies, the crown reinforcement plies, and the crown reinforcing profiled elements.

Only tire elements such as the bead reinforcing ring, or the toe protection rubbers, whose job is to ensure contact between the wheel rim and the lower region of the envelope, are made with compounds containing a carbon-based filler and still have the property of conducting electricity.

It is an object of the invention to provide a solution to the conduction of electrical charges in tires made essentially from poorly or very poorly electrically conducting rubber compounds.

“Poorly electrically conducting rubber material” is used here to refer to a rubber-based material with a resistivity of greater than or equal to 10⁸ Ohms/cm. Similarly, “electrically conducting rubber material” means a rubber-based material with a resistivity of less than 10⁶ Ohms/cm.

Thus, in general terms, the invention relates to a tire intended to be fitted to a wheel, and specially designed to reduce rolling resistance. Said tire comprises by way of indication:
A tread whose radially outer surface is designed to be in contact with the ground, said tread consisting, as a general rule, of a poorly electrically conducting compound and having a means for conducting electricity as described for example in publication EP 0 658 452.
A crown reinforcing belt formed by a plurality of reinforcing plies laid on top of each other, each reinforcing ply comprising threads parallel with each other and coated with a poorly electrically conducting rubber compound and making a given angle with the circumferential direction. The crown reinforcing belt is in contact with the radially inner surface of the tread, and more specifically with the means for conducting electricity arranged in the tread.
A toe region designed to ensure close contact between the wheel and the tire, comprising bead reinforcing rings, and toe protection rubbers in contact with the wheel, said toe protection rubbers being formed, as a general rule, from an electrically conducting rubber compound.
One or more carcass reinforcing plies laid on top of each other, anchored by their radially inner ends to the bead reinforcing rings, and also comprising threads coated with a poorly electrically conducting rubber compound, parallel with each other and making a given angle, generally 90°, with the circumferential direction. At its centre, the carcass reinforcing ply is in contact with one of the plies forming the crown reinforcing belt.
A sidewall region designed to protect the carcass reinforcing ply, and formed, as a general rule, from a poorly electrically conducting rubber compound.

The term “thread” should be understood extremely broadly, to include a monofilament, a multifilament, a cord or yarn or equivalent assembly, irrespective of what the textile or metallic material of the thread is, or the treatment which it may undergo, such as rubber coating or a surface treatment, to promote its intimate adhesion to the rubber.

The problem that therefore occurs in the type of tire described above is how to provide a conducting pathway between the tread and the wheel rim, because the reinforcing plies no longer conduct electrical charges between the crown of the envelope and the lower region.

The object of the invention is to provide a solution to this problem by providing adapted crown reinforcing plies and carcass reinforcing plies.

The reinforcing plies according to the invention are formed of an assembly of threads, mostly coated with a poorly electrically conducting rubber compound, parallel with each other and making a given angle with the longitudinal direction of said ply.

These plies are characterized in that so-called “through-threads” coated with one or more layers of rubber compounds, of which the outer layer is formed of an electrically conducting rubber compound, are inserted between the threads coated with the poorly electrically conducting rubber compound at a pitch and in a given arrangement in such a way as to form one or more electrically conducting pathways between the upper part and the lower part of the ply.

It is then observed that by carefully adjusting the pitch and arrangement of the through-threads, one or more conducting pathways are created between the inner part of the tread and the lower region, because of the successive contacts between the through-threads situated on the reinforcing plies of the crown belt and the carcass reinforcing plies laid on top of each other.

The presence of a small number of threads coated with an electrically conducting rubber compound does not significantly modify the overall performance of the tire in terms of resistance to forward movement.

Furthermore, the electrically conducting compound coating the threads of the various reinforcing plies is carefully chosen to give approximately the same mechanical performance as the poorly electrically conducting compound with which the threads of said ply are coated.

The invention also relates to the preferred embodiments of a ply according to the invention, and to a tire comprising plies according to the invention.

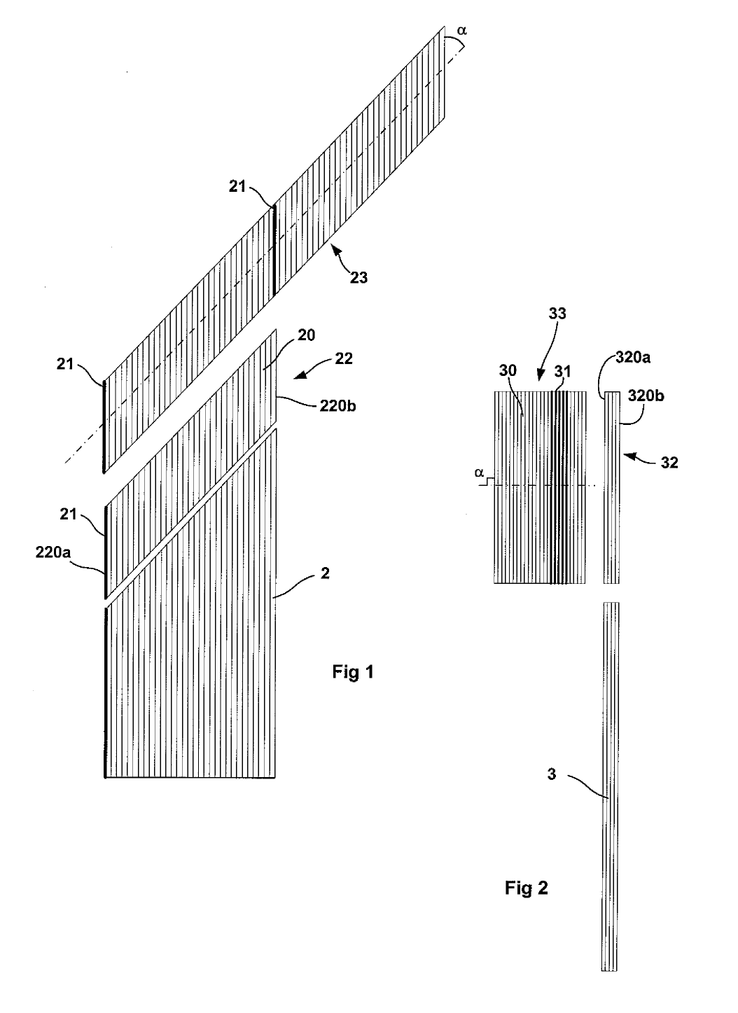

The description which follows is based on FIGS. 1 to 10, in which:

FIGS. 1 and 2 are schematic top views of reinforcing plies according to the invention,

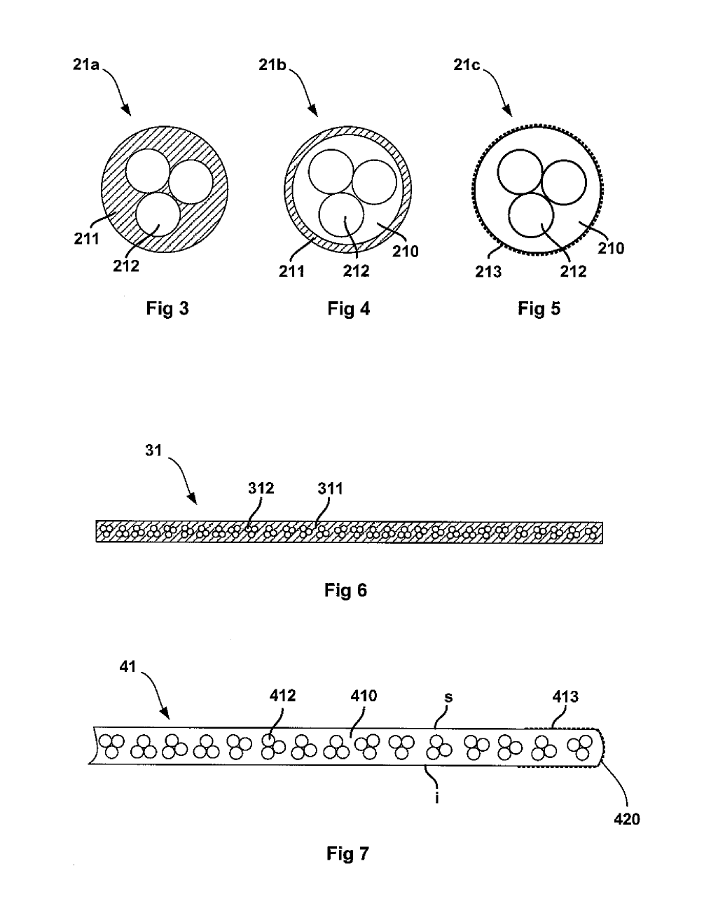

FIGS. 3, 4 and 5 are cross sections through a through-thread according to the invention,

FIG. 6 is a cross section through a reinforcing through-strip according to the invention,

FIG. 7 is a cross section through a reinforcing ply whose selvedge is according to the invention,

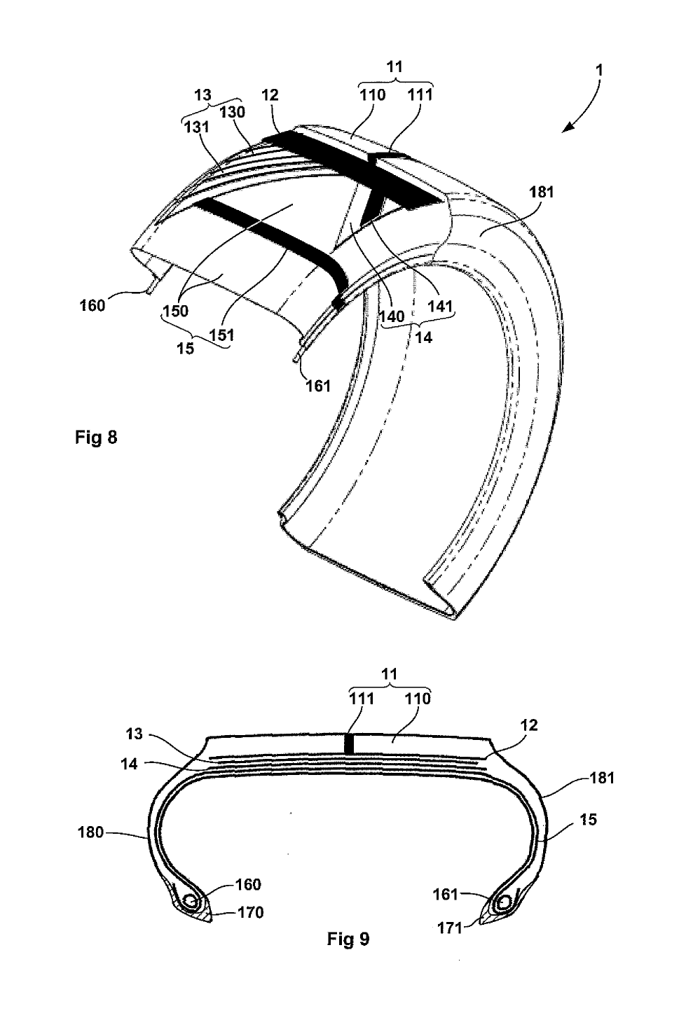

FIG. 8 is a cutaway view of a tire comprising crown reinforcing plies and carcass reinforcing plies according to the invention,

FIG. 9 is a radial cross section through said tire, and

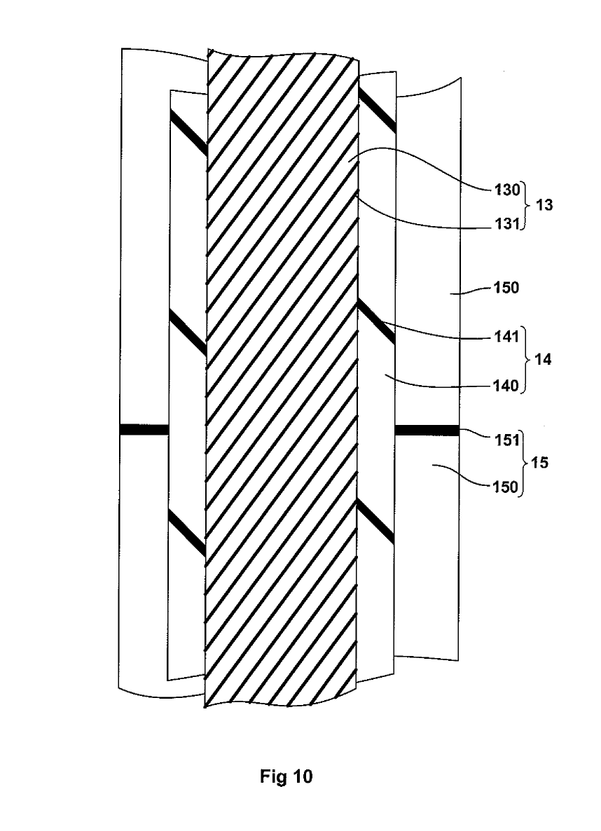

FIG. 10 is a schematic top view of the reinforcing plies forming the crown belt arranged on a carcass reinforcing ply.

The reinforcing plies 23 and 33 from which a tire is to be made, as shown in FIGS. 1 and 2, are formed of lengths of threads, parallel with each other, which make an angle (α) with the longitudinal direction of the ply. The reinforcing ply 23, shown in FIG. 1, the threads of which make an angle α of less than 90° with the longitudinal direction, is preferably designed to be used to make a crown reinforcing belt. The ply 33 shown in FIG. 2, the threads of which make an angle α with the longitudinal direction of approximately 90°, is preferably designed for making a carcass reinforcing ply.

The threads (20, 30) are mostly coated with a poorly electrically conducting rubber compound. Lengths of through-threads (21, 31) are inserted between the threads coated with the poorly electrically conducting compound at a pitch and in a given arrangement.

FIG. 1 illustrates the case in which the lengths of through-threads 21 are arranged in isolation between multiple threads coated with a poorly electrically conducting compound. FIG. 2 illustrates the case in which multiple through-threads 31, laid side by side, are arranged between multiple threads coated with a poorly electrically conducting compound.

The manufacture of the reinforcing plies comprises, in a known manner, the following steps. Cutting at a given angle α allows removal of lengths of plies (22, 32), in a “straight-thread” ply (2, 3). In the present case the straight-thread ply consists of continuous threads coated with a poorly electrically conducting rubber compound, the threads being parallel with each other and making an angle of 0° with the longitudinal direction of said straight-thread ply. The number of threads laid side by side in a straight-thread ply may vary depending on the nature and diameter of the thread in a group of 10 or so threads (3)—in which case they will be called a strip—all the way up to one or two thousand threads—which are then known as very wide plies (2). The selvedges of the lengths bordered by a thread (220a, 220b, 320a, 320b) are then spliced together to obtain an endless reinforcing band (23, 33).

One method of obtaining a reinforcing ply that makes it possible to produce reinforcing plies in accordance with the invention would be to slit a very wide straight-thread ply to form a plurality of straight-thread strips, between which endless through-threads would then be inserted. The rubber bridges would be reformed by splicing the selvedges together and bonding the uncured rubber compounds to themselves, in such a way as to produce a straight-thread ply containing through-threads.

An alternative that is easier to implement is more simply to insert, by splicing the selvedges of said lengths of plies bordered by a thread, a length of through-thread (21) or of through-strip (31) that has been ready cut to the desired angle, between each of the lengths of plies taken from a straight-thread ply (2, 3) in which the threads are coated with a poorly electrically conducting rubber compound. The result is an endless reinforcing band (23, 33) in accordance with the invention.

Lengths of a given dimension are then taken from said reinforcing band to form a reinforcing ply designed to be assembled with the other rubber components forming the unfinished tire.

In an equivalent way, the through-thread or through-strip can be added directly by edging one of the selvedges of the ply or the straight-thread strip.

The through-thread can be made by a conventional sheathing method, coating a thread 212 directly with the aid of an electrically conducting compound 211 as shown in FIG. 3. One alternative is to coat the thread 212 with a poorly electrically conducting compound 210 and then, using a sheathing method (also known), coextruding a second layer on the outside, consisting of an electrically conducting rubber compound 211, as shown in FIG. 4. A second alternative is to deposit over the whole of the surface of a thread 212 coated with a poorly electrically conducting rubber compound 210 a rubber solution 213 formed of an electrically conducting rubber compound and a solvent, as FIG. 5 shows, where the rubber solution 213 is shown as dots. The solvent is evaporated off, and only the thin layer of electrically conducting rubber compound is left on the outer surface of the thread.

The through-strip 31 can be made in the same way, conventionally, by sheathing a ply of threads 312 comprising some tens of threads in an electrically conducting rubber compound 311.

It will be observed that it is possible to copy the principles set forth above, which consist in coating, in a rubber solution composed of a solvent and an electrically conducting compound (413), both the selvedge and the upper and lower surfaces connected to said selvedge, of a straight-thread ply or a strip (41) or a length of ply, the threads (412) of which are coated with a poorly electrically conducting compound (410), to obtain the same effects, as seen in FIG. 7. A conducting pathway is thus established between the upper part s and lower part i of the ply or strip.

The embodiments of the through-strips or threads and their insertion into a reinforcing band are given here by way of illustration, and in no way prejudice any other combination that leads to a result in accordance with the spirit of the invention.

The threads or strips coated with an electrically conducting compound may be arranged at a regular or irregular pitch. Care will nonetheless be taken so that, once arranged in a final place in the tire, there are one or more contacts between the through-threads or through-strips, so as to form conducting pathways between the radially outer part of the crown belt and the carcass reinforcing ply.

The number of through-threads in a ply may be very small. It has been shown experimentally that the presence of one through-thread per ply is enough to establish a conducting pathway. In practice, however, it turns out that this type of arrangement is more complicated to implement because it means arranging the plies so that, during the tire building phase, the conducting threads are laid on top of each other.

The tire 1, shown in FIG. 8 by way of illustration of the invention, comprises a tread 11 having means for conducting electricity between the outer surface of the tread, designed to be in contact with the ground, and the radially outer part of the crown reinforcing belt.

These means may consist in providing a tread made with an electrically conducting rubber material or, preferably, making a tread 11 formed from a poorly electrically conducting compound 110 with an insert 111 running radially through the tread. The tread 11 may also include a sublayer 12, itself formed from an electrically conducting compound or comprising a means of draining charges similar to that of the tread.

The crown reinforcing belt is made up of two reinforcing plies 13 and 14 in which the threads make a given angle with the circumferential direction of the tire envelope as shown in FIG. 8.

The reinforcing ply 13 is made, for example, by splicing together a number of strips 130 laid side by side, in which the threads are coated with a poorly electrically conducting compound, and in which one of the selvedges is formed by a through-thread 131 coated with an electrically conducting compound.

The reinforcing ply 14 is made, in another example of assembly, by splicing lengths of strips (140, 141). Most of the lengths of strips forming the ply are formed of lengths of strips (140) in which the threads are coated with a poorly electrically conducting compound. Lengths of through-strips (141) are inserted between the strips (140) whose threads are coated with a poorly electrically conducting compound.

The carcass reinforcing ply 15 is formed, by way of illustration, by assembling lengths 150 of threads coated with a poorly electrically conducting compound, between which, during the step of making said lengths on the machine on which the straight-thread ply is cut, a length of strip 151 formed of threads coated with an electrically conducting compound has been inserted.

The carcass reinforcing ply 15 is anchored by its two radially lower ends to toe reinforcing rings 160 and 161.

It goes without saying that each of the carcass and crown reinforcing plies can, without distinction, be made in accordance with one of the embodiments described above.

An alternative to these embodiments is where the threads are deposited directly in the final position on the unfinished tire. This method is described by way of example in publication EP 248 301 relating to a method of depositing threads by spraying, and in publication EP 353 511 about a method of applying a thread to a core by an unwinding process.

These methods are supplied from a source of continuous thread with a precoating of rubber compound. If this compound is poorly electrically conducting, it may be wise to deposit at regular intervals on the thread surface a surface layer of an electrically conducting compound. As an example, a rubber solution formed of an electrically conducting rubber compound and a solvent may be applied. The solvent is then simply evaporated off to leave a thread in which certain areas possess the property of conducting electricity.

When the threads are laid in their final positions, lengths of through-threads are created, the number of which depends on the length of thread precoated with an electrically conducting rubber compound, so that the resulting reinforcing ply possesses the properties of a reinforcing ply according to the invention.

The number and kind of reinforcing plies of the tire supporting the present description are not restrictive. Thus, without departing from the spirit of the invention, a crown reinforcing belt can be produced comprising more than two intersecting plies, and one or more so-called zero-degrees plies. Likewise, a tire comprising multiple carcass reinforcing plies can be produced.

FIG. 9 is a radial cross section through the tire 1 and shows the toe protection rubbers 170 and 171 designed to ensure contact between the toes of the tire and the wheel rim. These toe protection rubbers are in contact with the carcass reinforcing ply and comprise a means for conducting electricity from the inner part to the outer part in contact with the wheel rim. These toe protection rubbers are preferably made with an electrically conducting rubber compound.

Lastly, the tire 1 comprises sidewall protection rubbers 180 and 181. These sidewall protection rubbers are preferably made with a poorly electrically conducting rubber compound.

To summarize, the tread 11 comprises means (111, 12) that enable an electrically conducting pathway to be established between the radially outer part of the tread, designed to be in contact with the ground, and the radially inner part of said tread. The radially outer part of the crown reinforcing belt (13, 14) is in contact with the radially inner part of the tread (12). Also, the radially inner part of the crown reinforcing belt is in contact with the carcass reinforcing ply (15). Finally, the radially lower parts of the carcass reinforcing ply are in contact with the toe protection rubbers (170, 171), the latter being designed to establish an airtight contact with the wheel rim.

Owing to the contact between these various elements, and more specifically the contacts between ply parts in which the threads are coated with an electrically conducting compound, at least one electrically conducting pathway is established between the radially outer surface of the tire and the wheel rim, as shown schematically in FIG. 10.

The arrangements that make possible the creation of a conducting pathway may differ.

In a first configuration, the threads coated with an electrically conducting compound are arranged in the reinforcing ply in one or more predefined positions with respect to the longitudinal ends of each of each of the plies. The plies are laid on top of each other, taking care to ensure that threads coated in the electrically conducting compound are positioned in the tire at a predetermined azimuth. The conducting pathway between the plies is therefore located in a predefined way. As indicated earlier, this arrangement may give rise to a complication when assembling the tire, but it means that the number of through-threads coated with an electrically conducting compound can be reduced. It also means that the particular case of tires having multiple carcass reinforcing plies can be handled, in which the threads are parallel with each other, and for which it is necessary to provide one or more predefined coating regions of sufficient length in the circumferential direction to cover the through-threads.

It will be observed nonetheless that the length of the ply must be less than the developed ply during the tire building operation, so that each tire with a reinforcing ply made in accordance with this method can have at least one through-thread or through-strip.

On the other hand, in a second configuration, the reinforcing plies are laid on top of each other without particular attention to the azimuth in the tire of the threads coated in a conducting compound. In this case the pitch and arrangement of threads coated in an electrically conducting compound are determined in such a way that, statistically, at least one conducting pathway can be established between the different reinforcing plies, irrespective of the circumferential positions of the plies with respect to each other.

The invention therefore makes it possible to produce, in a simple way, a tire capable of efficiently eliminating electrostatic charges from the vehicle. Moreover, the proposed methods of construction for manufacturing said plies require no major changes to existing methods and can be put into effect at lower cost.

1. A reinforcing ply intended for the manufacture of a tire formed of an assembly of threads, mostly coated with a poorly electrically conducting rubber compound, parallel with each other and making a given angle with the longitudinal direction of said ply,
wherein the ply includes through-threads coated with one or more layers of rubber compounds, of which an outer layer is formed of an electrically conducting rubber compound, said through-threads being inserted between the threads coated with the poorly electrically conducting rubber compound, at a pitch and in a given arrangement in such a way as to form one or more electrically conducting pathways between an upper part and a lower part of the ply.

2. The reinforcing ply according to claim 1, wherein said threads coated with an electrically conducting rubber compound form subassemblies within which said threads lie side by side with each other, said subassemblies being inserted between the threads coated with the poorly electrically conducting rubber compound at a pitch and in a given arrangement.

3. The reinforcing ply according to claim 1, wherein the through-threads are coated with a single layer of electrically conducting rubber compound.

4. The reinforcing ply according to claim 1, wherein the through-threads are coated with a first layer of poorly electrically conducting rubber compound and an outer layer of an electrically conducting rubber compound.

5. A method of making a reinforcing ply intended for the manufacture of a tire, said ply being formed of an assembly of threads, mostly coated with a poorly electrically conducting rubber compound, parallel with each other and making a given angle with the longitudinal direction of said ply,
said method comprising a step during which through-threads coated with one or more layers of rubber compounds, their outer layer being formed of an electrically conducting rubber compound, are inserted between the threads coated with the poorly electrically conducting rubber compound at a pitch and in a given arrangement, in such a way as to form one or more electrically conducting pathways between an upper part and a lower part of the ply.

6. The method according to claim 5, comprising the steps of:
from a straight-thread ply in which the threads are coated with a poorly electrically conducting compound, predetermined lengths are taken at a given angle relative to the longitudinal direction of the straight-thread ply, to form lengths of plies;
one or multiple lengths of through-threads are spliced side by side along one of the selvedges of a length of ply at a pitch and in a given arrangement; and
said lengths of plies are laid side by side by splicing selvedges bordered by a thread to form an endless reinforcing band.

7. The method according to claim 6, wherein, to make a through-thread, a thread is coated with an electrically conducting rubber compound.

8. The method according to claim 6, wherein, to make a through-thread, coating of a thread is performed by coextruding a first layer formed of a poorly electrically conducting rubber compound and an outer layer formed of an electrically conducting rubber compound.

9. The method according to claim 6, wherein, to make a through-thread:
a thread is coated with a poorly electrically conducting compound;
a rubber solution formed of an electrically conducting rubber compound and a solvent is deposited over the whole of the surface of the thread; and
the solvent is evaporated off.

10. The method according to claim 5, comprising the steps of:
from a straight-thread ply in which the threads are coated with a poorly electrically conducting compound, predetermined lengths are taken at a given angle relative to the longitudinal direction of the straight-thread ply, to form lengths of plies;
a rubber solution formed of an electrically conducting rubber compound and a solvent is deposited, at a pitch and in a given arrangement, on one of the selvedges bordered by a thread and on the upper and lower surfaces connected to said selvedge of a length of ply or of the straight-thread ply;
the solvent is removed; and
said lengths of plies are laid side by side by splicing said selvedges bordered by a thread.

11. The method according to claim 5, wherein:
a continuous thread is coated with a poorly electrically conducting compound;
a surface layer of an electrically conducting rubber compound is deposited at defined intervals on the surface of the entire circumference of said thread, and along a given length of thread; and
said lengths of threads are deposited directly in a final position on a receiving surface.

12. The method according to claim 11, wherein the thin surface layer of electrically conducting rubber compound is produced by depositing a rubber solution based on a an electrically conducting rubber compound and a solvent which is evaporated off.

13. A tire comprising one or more carcass reinforcing plies and a crown reinforcing belt formed of one or more crown reinforcing plies, wherein said plies are formed from reinforcing plies according to claim 1.

14. The tire according to claim 13, further comprising a tread including means to conduct electricity between the outer surface of the tread, configured to be in contact with the ground, and the radially outer part of the crown reinforcing belt.

15. The tire according to claim 13, further comprising two toe regions containing toe reinforcing rings to which the radially lower ends of the carcass reinforcing ply or plies are anchored, and toe protection rubbers designed to be in contact with the wheel rim and positioned so that they are in contact with at least one of the carcass reinforcing plies, said toe protection rubbers being formed of an electrically conducting material.
